(19) United States
(12) Patent Application Publication
(10) Pub. No.: US 2015/0379186 A1
(43) Pub. Date: Dec. 31, 2015

(54) SYSTEM AND METHOD FOR GRADING AND SELECTING SIMULATION TESTS USING PROPERTY COVERAGE

(71) Applicant: ATRENTA, INC., San Jose, CA (US)

(72) Inventors: Yong Liu, Cupertino, CA (US); Jian Yang, San Jose, CA (US); Yuan Lu, Saratoga, CA (US)

(73) Assignee: ATRENTA, INC., San Jose, CA (US)

(21) Appl. No.: 14/745,700

(22) Filed: Jun. 22, 2015

Related U.S. Application Data
(60) Provisional application No. 62/019,333, filed on Jun. 30, 2014.

(51) Int. Cl. G06F 17/50

(52) U.S. Cl. CPC G06F 17/5081

(57) ABSTRACT

A method implemented as a test grading system (TGS) in a programmable computing system grades simulation tests according to their verification property coverage. The TGS identifies verification properties from one or more of the circuit design (e.g. RTL description), verification properties files and test simulation results, and determines verification property coverage for each test. That is, it finds out which verification properties are covered by each simulation test. According to a specified criterion, the TGS recommends a subset of the available tests based on their verification property coverage.

### CROSS-REFERENCE TO RELATED APPLICATION

This application claims priority under 35 U.S.C. 119(e) from U.S. provisional application no. 62/019,333, filed Jun. 30, 2014.

### TECHNICAL FIELD

This invention relates to the field of integrated circuits verification and in particular to verification by means of simulation. More particularly the invention relates to a system, method and computer program product for grading and selecting simulation tests.

### BACKGROUND ART

Electronic chip designers develop chips of ever increasing complexity using more and more transistors. A complex chip is often called a System-on-a-chip (SOC). SOC designer teams have difficulty in verifying that a SOC will meet the specification. SOC design teams typically develop hundreds and sometimes thousands of simulation tests for verification.

SOC design teams spend many months developing and running simulation tests. The SOC design teams typically run different subsets of the simulation tests at different times. After a designer changes any line of RTL, the designer will usually run a small regression test suite to quickly verify the changes. The SOC design team will typically run a weekly test suite once a week. A considerable amount of engineering time is spent running and analyzing simulation results.

SOC design teams want to ensure that the SOC design works in all modes and configurations. They want to ensure that all lines of RTL code are exercised. To reduce SOC development time the SOC design teams also want help in simulation test selection. They want to avoid running tests that check the same functionality. The SOC design teams need to select daily and weekly test suites that can run in an appropriate time.

SOC design teams typically use simulators to generate code coverage reports. They analyze these reports and try to ensure all lines of RTL code are exercised. The SOC design teams often find “dead-code”, code that isn't needed. The code coverage reports provide a large volume of detailed information. Designers find it difficult to use code coverage to help in selecting test sets.

Electronic design automation (EDA) tools are making increased use of verification properties to reduce the verification cost. A verification property declares a condition in the design. If a property always holds true, we call them an assertion. For example, a property “overflow == 1′b0” should always hold for any correct FIFO design. On the other hand, a property can capture possible behavior allowed by the design; we call such a property a cover property. For example, a property “full ==1′b1” can be a typical coverage property on the same FIFO design. For the given above two examples, we typically write them as:

assert overflow == 1′b0

cover full == 1′b1

Verification properties can define relationships between signals on different cycles, e.g., if there is a request on cycle N, there should be an acknowledge generated on cycle N+1. User can specify verification properties in an RTL file or in a separate properties file. They are typically written in languages such as System Verilog Assertions (SVA) and Property Specification Language (PSL). Many EDA tools can parse/generate verification properties. Some EDA tools can generate verification properties by analyzing RTL statements. Other EDA tools can generate verification properties by analyzing simulation test results.

Arenta's Bugscope™ EDA tool has proven valuable in finding test coverage holes. Bugscope™ generates verification properties by analyzing RTL statements and analyzing simulation test results. For example it may note that in one test the condition “full == 1′b0” is always true. If Bugscope™ discovers that the same condition is false in a second test it treats the condition as a coverage property and generates the property “cover full == 1′b1”. The coverage property condition is inverted with respect to the discovered property to direct a simulator to check for the inverted condition. We say that the second test covers the property. Bugscope™ may note that the condition “overflow == 1′b0” is always true in all tests. In this case it generates an assertion.

Simulators can check property statements. For example, given the property “assert overflow == 1′b0” a simulator will signal an error if the overflow signal ever has the value 1. For the property “cover full == 1′b1”, a simulator can report if this property is covered in a particular test or not.

### SUMMARY DISCLOSURE

A test grading system (TGS) carries out a method in a programmable computing system in order to determine verification properties and select simulation tests based on their coverage of such verification properties. In particular, verification properties are determined from one or more of the circuit design, verification properties files and test simulation results. Then, verification property coverage is determined for each test. Verification property coverage is generated (1) by a simulator that runs tests along with the properties; or (2) by the TGS itself by analyzing simulation test results. The TGS finds which verification properties are covered by each simulation test and then recommends a subset of tests based on their verification property coverage, showing the test grading results to an end-user. The end-user should specify to the TGS what criterion to use for recommending a subset of tests. For example, the TGS's recommendation may be to select the minimal subset of tests that will cover the maximum number of properties, or the subset of tests that cover the maximum number of properties and have the minimum Simulation time. A particular subset of simulation tests is selected based on their property coverage.

### BRIEF DESCRIPTION OF THE DRAWINGS

FIG. 1 shows a flowchart outlining the steps of the test grading system.

FIG. 2 shows an example of the test grading system generating a coverage property set.

FIG. 3 shows an example of the test grading system generating a property coverage report.

FIG. 4 shows an example of the test grading system generating an optimized test set.

FIG. 5 shows a block diagram of the test grading system.

### DETAILED DESCRIPTION

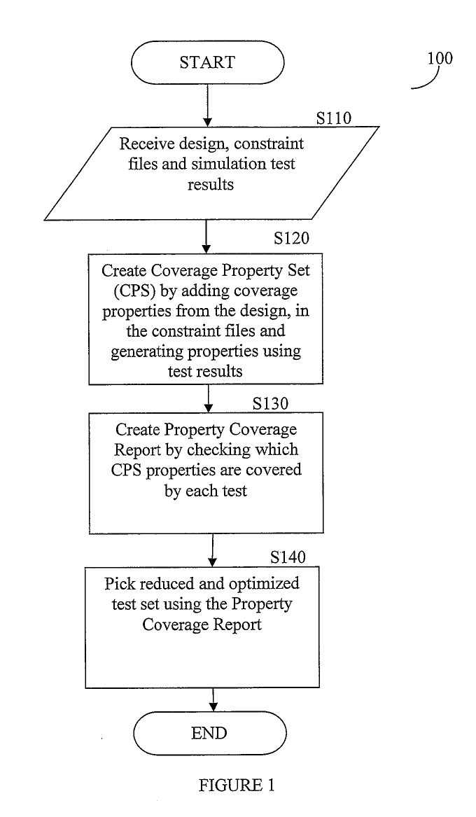

FIG. 1 is an exemplary and non-limiting flowchart 100 for grading simulation tests according to their verification property coverage. The test grading system (TGS) grades simulation tests according to their verification property coverage. The TGS identifies verification properties, finds which verification properties are covered by each simulation test and then recommends a subset of tests based on their verification property coverage. In S110 the TGS receives the design; any properties files and optionally test simulation results. The design is usually contained in one or more files and written in a design language such as Verilog or VHDL. Verification properties can be specified directly in the design by the developer. Verification properties can optionally be specified in separate files and written in languages such as System Verilog Assertion (SVA) and Property Specification Language (PSL). Verification properties can be manually specified by a developer or generated automatically by EDA tools. When directed by an end-user the TGS will derive new verification properties from the design. When directed by an end-user, the TGS will derive new verification properties from test simulation results.

In S120 the TGS accumulates all the coverage verification properties and calls them the coverage property set (CPS). The TGS accumulates coverage verification properties specified in the design, specified in property files and any coverage verification properties it derives. The TGS optionally derives coverage verification properties from the design and test simulation results. In S130 the TGS evaluates each of the simulation tests noting which of the CPS verification properties is covered by that test. The information of which CPS properties are covered by each test is called the property coverage report (PCR). In one mode the TGS checks the test simulation results to see if the coverage properties are covered. In a second mode the TGS launches a simulation for each simulation test. The simulation accepts (1) the test stimuli specific to the test, (2) the design to simulate, and (optionally) (3) coverage properties to test for coverage. If the simulator accepts coverage properties, the simulation generates property coverage data for each test. If the simulator does not accept coverage properties, the simulation generates simulation results consisting of signal values for each test. The TGS derives property coverage data for each test by checking if the signal values satisfy each property. In either case, the TGS accumulates this property coverage data for each test into the PCR.

In S140 the TGS selects a set of tests using the PCR. In one embodiment the TGS selects the smallest set of tests that cover all the CPS verification properties. In another embodiment the TGS selects the test set that covers the CPS and has minimum simulation time. In yet another embodiment the TGS interacts with a user and helps the user select an appropriate set of tests. The user views the PCR. The user indicates which verification properties he or she wishes to cover and asks the TGS to generate test sets covering those verification properties.

In one embodiment the TGS uses a greedy algorithm to select the minimum number of tests that cover all the CPS properties. The TGS finds the test that covers the most as-yet-uncovered properties and adds that test to the selected set. The TGS repeats this until all properties are covered.

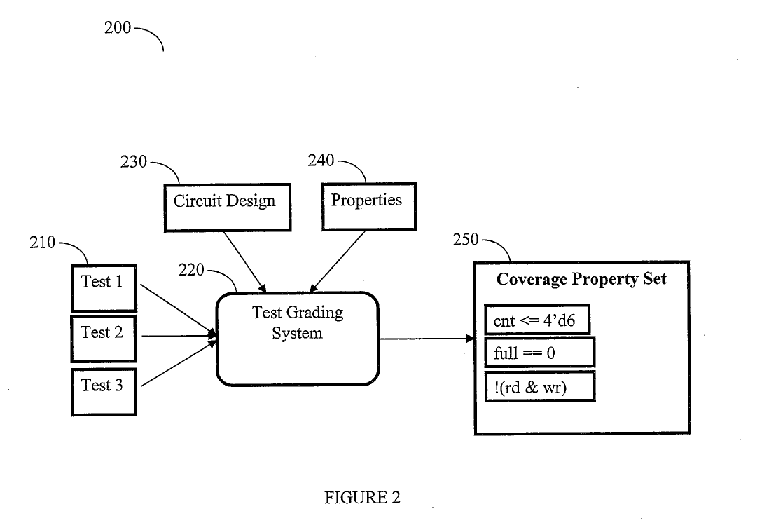

FIG. 2 shows the TGS 220 generating a sample CPS. The TGS 220 reads the test simulation results 210, the circuit design 230 and verification properties 240. The TGS 220 produces a CPS 250 containing three verification properties. The first verification property “cnt<= 4′d6” is read from a property statement in an RTL circuit design file 230. The second verification property “full == 0” is read from a PSL property file 240. The third verification property “!(rd & wr)” is derived from the simulation data results 210.

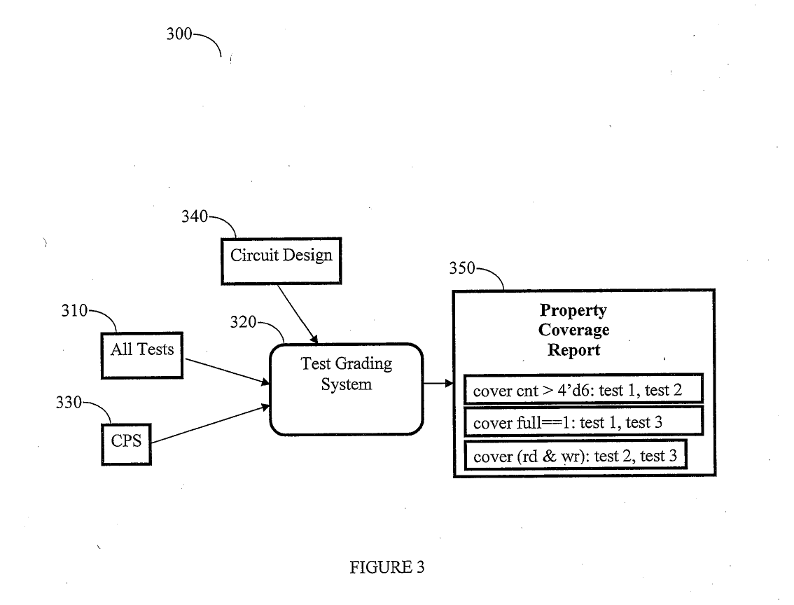

FIG. 3 shows the TGS 320 generating a sample PCR 350. In one embodiment the TGS 320 checks the test simulation data 310 to see which properties are covered by each test. The TGS generates a PCR 350. In a second embodiment the TGS 320 simulates the design 340 using each of the simulation tests 310 by running simulator. The TGS 320 reads the CPS 330 and constructs property coverage statements that direct the simulator to generate property coverage data. The TGS 320 combines the property coverage data to create a PCR 350. The PCR 350 shows that the first property is covered by test1 and test2, the second property is covered by test1 and test3, and third property is covered by test2 and test3. The coverage properties shown in PCR 350 are inverted with respect to the CPS properties 250 because the TGS is checking for the inverted condition.

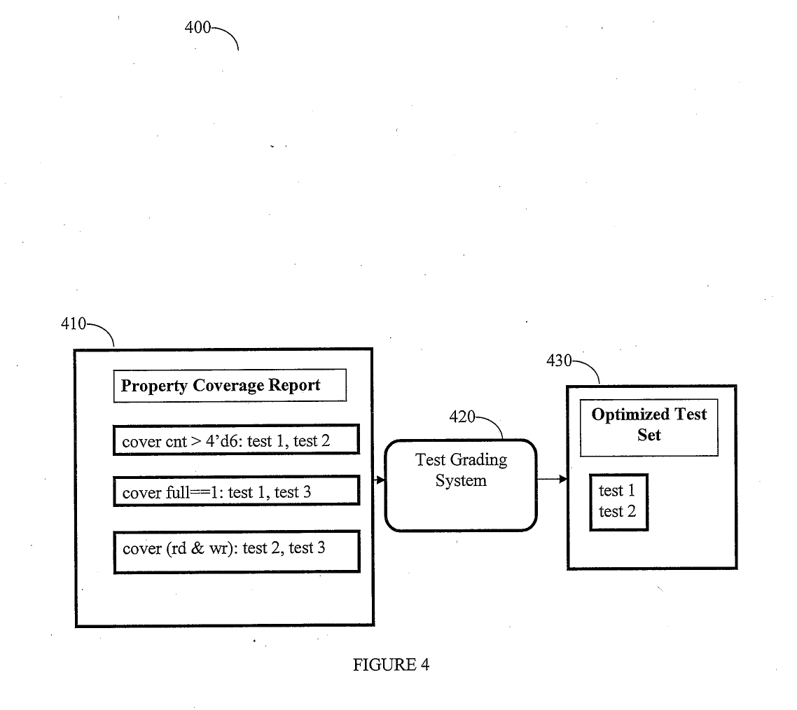

FIG. 4 shows the TGS 420 selecting a sample optimum test set 430. The TGS 420 reads the PCR 410. The TGS determines that simulating test1 and test2 will cover all three verification properties. With test1 and test2 selected there is no need to simulate test3.

The embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

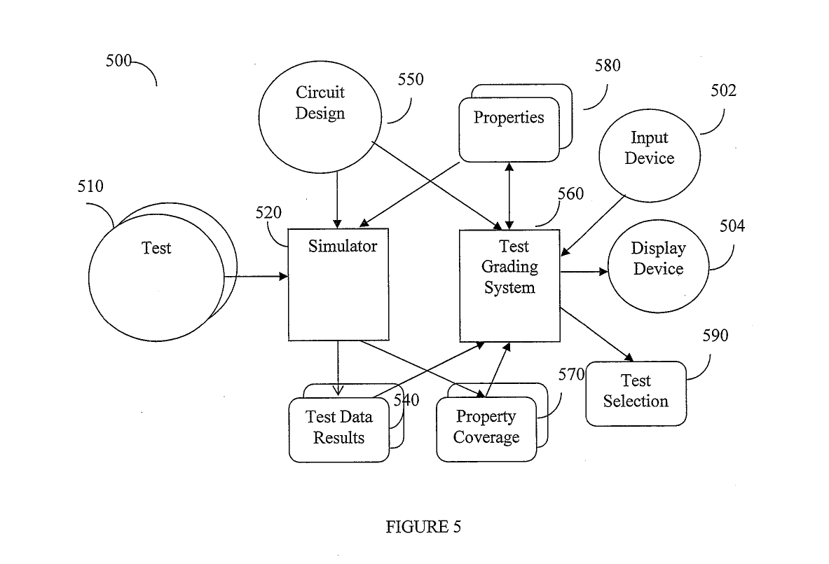

FIG. 5 is an exemplary and non-limiting diagram 500 showing a test grading system (TGS) 560. The TGS 560 runs as an application program on a central processing unit (CPU). The TGS 560 interacts with a user through an input device, 502 and a display, 504. Using the input device 502 the user starts the TGS 560 execution and specifies TGS 560 inputs. In one embodiment the TGS 560 displays the test selection 590 on the display, 504.

The simulator 520 is another application program running on a CPU. In one embodiment the TGS 560 controls the simulator 520. In another embodiment a user controls the simulator 520. The simulator 520 reads test stimuli 510 and a circuit design 550. The simulator 520 produces test data results 540. Under user direction through input device 502 the TGS 560 reads one or more of the test data results 540, the circuit design 550 and properties 580. The TGS 560 creates a CPS containing the coverage verification properties it found in the circuit design 550 and the properties 580. The TGS 560 optionally derives verification properties using the. circuit design 550 or the test data results 540. The TGS 560 adds any derived coverage verification properties to the CPS.

In one embodiment the TGS 560 derives a PCR by evaluating the test data results 540 and seeing which CPS coverage properties are covered by each test. In a second embodiment the TGS 560 stores the CPS as coverage properties in a property file 580. The TGS 560 or a user invokes the simulator 520 using coverage properties in property file 580. The simulator 520 generates coverage property data 570. The TGS 560 reads the coverage property data 570 and generates a PCR. The TGS 560 uses the PCR to generate a Test Selection 590.

What is claimed is:

1. A method, implemented as a test grading system in a programmable computing system, for selecting among simulation tests based upon a determination of coverage of verification properties of said tests, the method comprising:
receiving a set of simulation tests into memory accessible to a processor of the programmable computing system;
determining coverage properties from any one or more of (1) a circuit design, (2) verification properties files and (3) test simulation results;
grading each of the received simulation tests, by the processor executing the test grading system, by determining a coverage of verification properties of the respective tests;
showing test grading results of determined coverage to an end-user on a display of the programmable computing system; and
selecting a subset of simulation tests to be run, based on their property coverage in relation to user-specified properties to be verified.

2. The method as in claim 1, wherein the property coverage is determined from one or more of:
a property coverage report generated by a simulator; and
checking of simulation data for property coverage.

3. The method as in claim 1, wherein at least one coverage property is automatically generated from simulation results.

4. The method as in claim 1, wherein at least one coverage property is automatically generated from a register transfer level (RTL) description of a circuit.

5. The method as in claim 1, wherein at least one coverage property is automatically generated from both a register transfer level (RTL) description of a circuit and data from test simulation results.

6. The method as in claim 5, wherein test simulation results are obtained from RTL tests.

7. The method as in claim 1, wherein an end-user specifies which properties the end-user wants to cover and which criterion to use for selecting the subset of simulation tests to be run.

8. The method as in claim 7, wherein the criterion for selecting the subset of simulation tests is one that selects a minimal subset of tests covering the maximum number of specified properties.

9. The method as in claim 7, wherein the criterion for selecting the subset of simulation tests is one that covers the maximum number of specified properties with a minimum simulation time.

10. A test grading system selecting among simulation tests based upon a determination of coverage of verification properties of said tests, the system comprising:
a computer processor;
a memory accessible to the computer processor for storing a received set of simulation tests;
an input device for receiving from an end-user at least a set of properties to be verified by the simulation tests; and
a display for showing test grading results to an end-user;
wherein the processor determines coverage properties from any one or more of (1) a circuit design, (2) verification properties files and (3) test simulation results, grades each of the received simulation tests by determining a coverage of verification properties of the respective tests, shows test grading results of determined coverage to an end-user on the display, and runs a subset of simulation tests, that are selected based on their property coverage in relation to received user-specified properties to be verified.

11. The system as in claim 10, wherein the property coverage is determined from one or more of:
a property coverage report generated by a simulator; and
checking of simulation data for property coverage.

12. The system as in claim 10, wherein at least one coverage property is automatically generated from simulation results.

13. The system as in claim 10, wherein at least one coverage property is automatically generated from a register transfer level (RTL) description of a circuit.

14. The system as in claim 10, wherein at least one coverage property is automatically generated from both a register transfer level (RTL) description of a circuit and data from test simulation results.

15. The system as in claim 14, wherein test simulation results are obtained from RTL tests.

16. The system as in claim 10, wherein an end-user specifies which properties the end-user wants to cover and which criterion to use for selecting the subset of simulation tests to be run.

17. The system as in claim 16, wherein the criterion for selecting the subset of simulation tests is one that selects a minimal subset of tests covering the maximum number of specified properties.

18. The system as in claim 16, wherein the criterion for selecting the subset of simulation tests is one that covers the maximum number of specified properties with a minimum simulation time.
